(19) United States
(12) Patent Application Publication
(10) Pub. No.: US 2017/0121076 A1
(43) Pub. Date: May 4, 2017

(54) MEDICINAL STORAGE-INCORPORATING COVER FOR CUPS

(71) Applicant: Marc Chase Weinstein, Roslyn Heights, NJ (US)

(72) Inventor: Marc Chase Weinstein, Roslyn Heights, NJ (US)

(21) Appl. No.: 15/339,880

(22) Filed: Oct. 31, 2016

Related U.S. Application Data
(60) Provisional application No. 62/249,246, filed on Oct. 31, 2015.

(51) Int. Cl. B65D 51/28; A61J 1/03; A47G 19/22; A61J 7/00; B65D 43/02; B65D 43/16

(52) U.S. Cl. CPC B65D 51/28; B65D 43/0225; B65D 43/16; A47G 19/22; A61J 7/0007; A61J 1/03; A47G 2019/2277

(57) ABSTRACT

Embodiments of the present invention provide a cover of a collapsible cup. According to one embodiment, a device comprises a cover for a cup, the cover comprising a lid having a periphery, a peripheral wall extending from the periphery of the lid generally oblique or perpendicular to the general orientation of the lid, and a compartment attached to or formed within the lid, the compartment forming a unitary structure of the lid and the compartment, wherein the compartment extends beyond the periphery to create an overhang portion of the compartment beyond the lid.

### CROSS-REFERENCE TO RELATED APPLICATIONS

This application claims the benefit of the U.S. Provisional Application No. 62/249,246, filed on Oct. 31, 2015, which is hereby incorporated by reference in its entirety.

### FIELD OF THE INVENTION

Embodiments of the present invention generally relate to the field of covers for cups, and more particularly to a cover incorporating storage for medicines.

### BACKGROUND

A variety of cups are now commonplace, for example, for drinking water, thereby assisting in taking medicines orally, or in general use for beverage consumption. Various cups include disposable cups, metallic cups, collapsible cups, and the like. Collapsible cups generally include a cover and a base, both of which are generally larger than the cup to provide an enclosure for conveniently carrying the cup in collapsed state. Non-collapsible cups may include or be provided with a cover to form an enclosed volume.

Generally, persons who take medicines frequently due to various kinds of indisposition tend to use collapsible cups because the collapsible cups are easy to carry around, and convenient even when travelling. Such persons may include elderly or persons who are impaired. Impairments may be associated with reduced mobility of limbs, reduced vision, among other impairments. In general, impairments may make manipulation of a cup, including regular or collapsible cup, difficult.

For example, a person with reduced hand mobility would find opening the cover of the collapsible cup of the pill-box, and/or gripping the base of the collapsible cup challenging. A person with reduced vision would find it difficult to differentiate between the cover and base, and find it difficult to remove the cover from the base for de-collapsing the cup. In general, impaired persons may find removing a cover from a regular, non-collapsible cup challenging for similar reasons.

Therefore, it would be desirable to have an improved cover for a cup.

### SUMMARY

Embodiments of the present invention provide a cover of a cup, substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIGS. 1A, 1B and 1C depict a collapsible cup comprising a storage-incorporating cover having a compartment, according to one or more embodiments.

FIGS. 2A, 2B and 2C depict the storage-incorporating cover having a rectangular compartment, according to one or more embodiments.

FIG. 3 depicts, a storage-incorporating cover having a circular compartment, and a circular platform, according to one or more embodiments.

FIG. 4 depicts a storage-incorporating cover having square shaped compartment and the base having a ridge, according to one or more embodiments.

FIG. 5 depicts a storage-incorporating cover having rectangle shaped compartment and the base having the ridge, according to one or more embodiments.

FIG. 6 depicts a storage-incorporating cover having circle shaped compartment and the base having the ridge, according to one or more embodiments.

FIG. 7 depicts the base having two protruding ridges, according to one or more embodiments.

FIG. 8 depicts the ridge having a textured area, according to one or more embodiments.

FIG. 9 depicts the compartment having a hinged cover with a cutting element, according to one or more embodiments.

FIGS. 10A-C depict a storage-incorporating cover having screw threads, according to one or more embodiments.

FIG. 11 depicts a storage incorporating cover having recesses for finger grips, according to one or more embodiments.

### DESCRIPTION

The present invention comprises a cover for a drinking cup, where the cover contains or incorporates a storage space. For example, a cover for a cup for drinking water, incorporating storage for medicines. Covers are especially common for collapsible cups, and collapsible cup art includes various methods to accomplish the collapsibility, including rigid multiple concentric rings that are able to be extended in an upward direction by being pulled up by the user, so as to form a liquid holding area for drinking etc., and a single piece flexible “rubber” type material that also has the ability to fold down upon itself in an accordion-type manner so as to form a compressed/reduced size. Covers for collapsible cups are typically engaged with a base on which the concentric rings are disposed.

The present invention improves upon known covers for non-collapsible or collapsible cups by providing a cover for a cup, where the cover incorporates storage, which extends beyond the cover, creating an overhang portion of the storage, which overhang yields additional benefits for the user. For example, the overhang portion provides an easy grip to a user to twist and remove the cover from the cup. The coers may be engaged with the cup of the base of the cup via a friction fit, or via a screw arrangement, and the overhang allows for a grip in both configurations. Additional assistance in grip may be provided by adding ridges to the base to provide a grip in the opposing twisting motion to further ease the removal of the cover from the cup. Even additionally, the overhang portion of the cover, or the ridges of the base are shaped to include recesses that make it easy for fingers to grip such recesses, further easing the process of twisting and removing the cover from the cup. Covers are particularly commonplace in collapsible cups, and are engaged with the base of the collapsible cup, and while further discussion is made with reference to collapsible cups having a cover and a base enclosing the collapsible cup within, it is understood that the cover described herein may be used equally well with non-collapsible cups, and engage with the opening of the cup. The storage space, for example, a compartment is incorporated within the cover such that the compartment has at least one dimension that is larger than the cover. For simplicity, the compartment portion of the cover is referred to as the compartment, while the rest of the portion is referred to as the lid, and in general, the storage-incorporating cover may also be viewed as a lid with one or more compartments therein. The larger outer dimension of the compartment forms an overhang of the compartment extending beyond the lid, which allows a user to grasp the edges of the compartment easily, for example to twisting, turning, pulling, or otherwise removing the cover off the cup. Therefore, the overhang portion provides additional storage to the compartment, while simultaneously providing an additional grip for a user to remove the cover from the cup.

Additionally the present invention may also include the use of a gripping elements, for example, ridges, protruding from the base of the cup. The gripping elements include ridges having a dimension larger than the base of the cup, or a texture in the gripping area on the lateral portion of the base, which allows the gripping element to be gripped simultaneously, thereby allowing for an application of a force opposing the force applied on the compartment overhang, further easing the process of removing the cover from the cup.

These features, alone, and in combination, provide a significant functional improvement for any user due to a better ease of use when separating the top cover from the base, and for anyone with impairments involving hand strength, motor planning, sight restrictions, and the like. Further, the overhang portion grip of the cover and/or the gripping elements along the base also enable a user to engage the cover with the cup, whether a collapsible cup, or a non-collapsible cup.

Several shapes of the compartment and the overhang thereof are possible so as to provide a convenient grip, for example, polygons providing an edge protrusion, other shapes providing recesses for fingers to engage. Further, the overhang portion edges may further include a roughened surface to enhance the grip. The shape of the overhang includes several regular shapes, for example, a circle or a portion thereof, a rectangle or a portion thereof, a polygon or a portion thereof, or irregular shapes that may be formed using a combination of the regular shapes or other shapes, for example, animal outline shapes, such as a cat face, or an elephant body, and the like. For simplicity, regular shapes, such as rectangles and circles have been described herein, but the embodiments described herein are not restricted to such shapes.

The larger outer dimension creating the overhanging compartment provides more space for storage, and for example, in the case of a pill box, there is more room for storing pills in the compartment. The additional space may also be used to create multiple separate compartments instead of a single compartment. These compartments can allow the user to separate and keep track of the contents in many ways, including by type of pill or by time of day, by medical requirements (i.e., all morning pills in one cavity, all afternoon pills in another, evening), etc. In turn, the compartments also comprise a compartment lid or lids. The compartment lid of these separate compartments can be in form of a single compartment lid which covers all compartments, or multiple compartment lids corresponding to one or two compartments, to allow for access to only a particular compartment while all the other compartments remain closed. The compartment lids can also be transparent to allow direct viewing of the contents without opening the cover, and thereby provide a visual indication if the pills have been taken or if they need to be refilled.

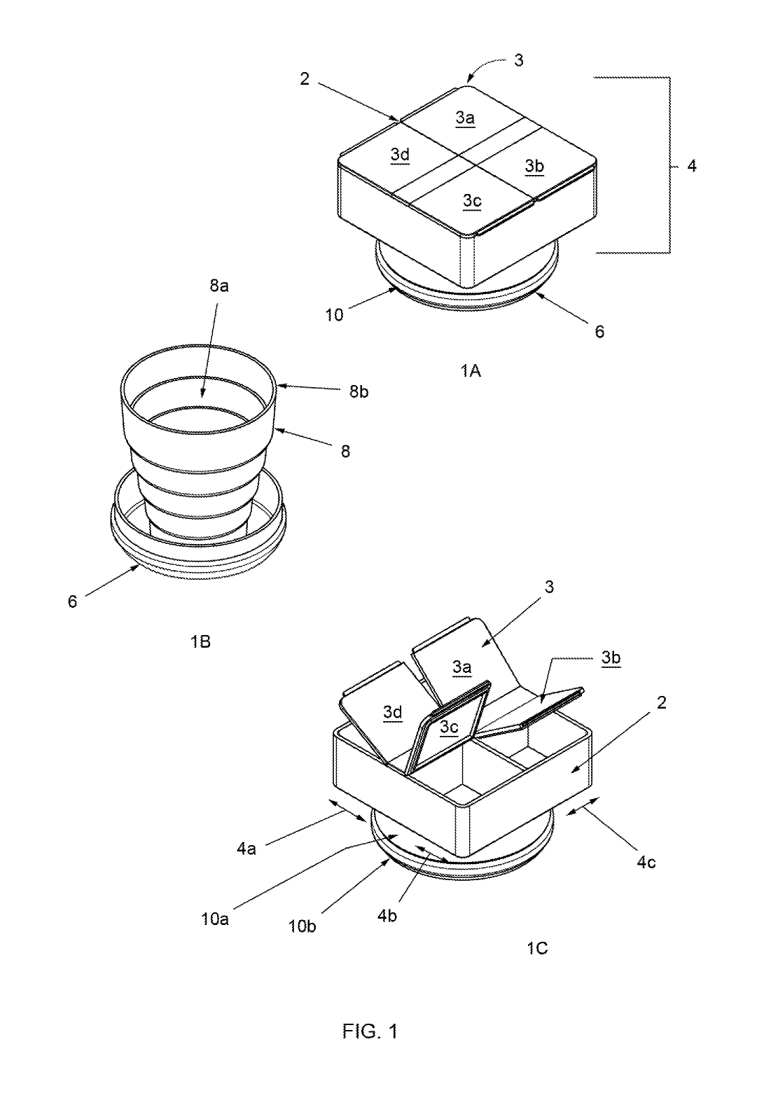

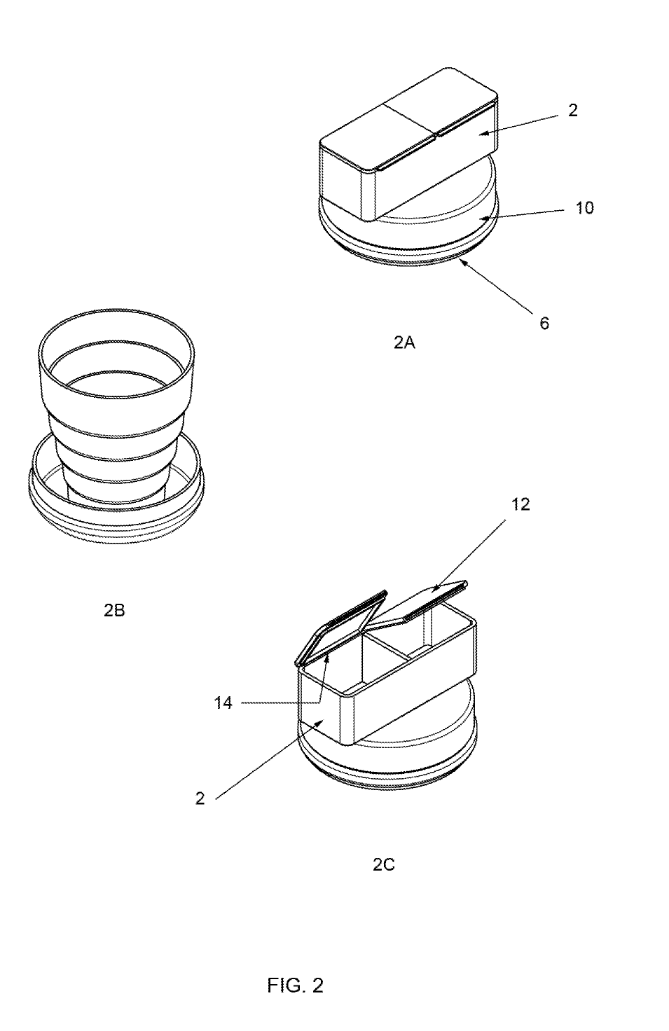

There are various ways to provide the above-noted features, only some of which are illustrated herein as exemplary. FIGS. 1A, 1B and 1C depict a collapsible cup 8 comprising a cover 4. In one embodiment, the collapsible cup 8 is formed of a plurality of concentric rings of successively increasing size, where the smallest diameter ring is attached to the base 6. As depicted in FIG. 1A, the collapsible cup 8 is enclosed in a collapsed state between the cover 4 and a base 6. The cover 4 comprises a lid 10 or platform 10, and a compartment 2 or a storage 2, according to one or more embodiments. While the compartment 2 is illustrated as being positioned atop the outer side 10A, the compartment can also be inset the lid 10 or the platform 10, extending through the lid at least partially. FIGS. 1A and 1C depict the cover 4 having a square shaped compartment 2 divided into four equally sized compartment. Each of the four equally sized compartments have an individual compartment lid 3a, 3b, 3c, 3d, which engage with the respective compartments to form an enclosed volume between the compartment lid and the compartment. The platform 10 comprises an inner side 10B facing an opening 8B of the collapsible cup 8 and an outer side 10A facing the opposite side of the inner side 10B. The compartment 2 is incorporated to be accessible from the outer side 10A. Although the compartment 2 has a square shape, the lid or the platform 10 is circular, as shown in FIG. 1C, so as to correspond to and engage with the shape of the cup base 6, and form a friction fit therewith, or in some embodiment, mate with the base using a screw thread formed thereon.

The shape and positioning of the compartment 2 results in portions of the compartment 2 that overhang the round shape of the platform 10 to form one or more overhanging areas depicted as 4a, 4b and 4c in FIG. 1C. The one or more overhanging areas assist the user gripping the top cover 4 and separating it from the base 6, when opening the cup 8 for use. According to one embodiment, the one or more overhanging areas are opposite to each other, for example, the overhanging areas 4a and 4c. Such opposite overhanging areas 4a and 4c provide opposing areas for gripping the cover 4.

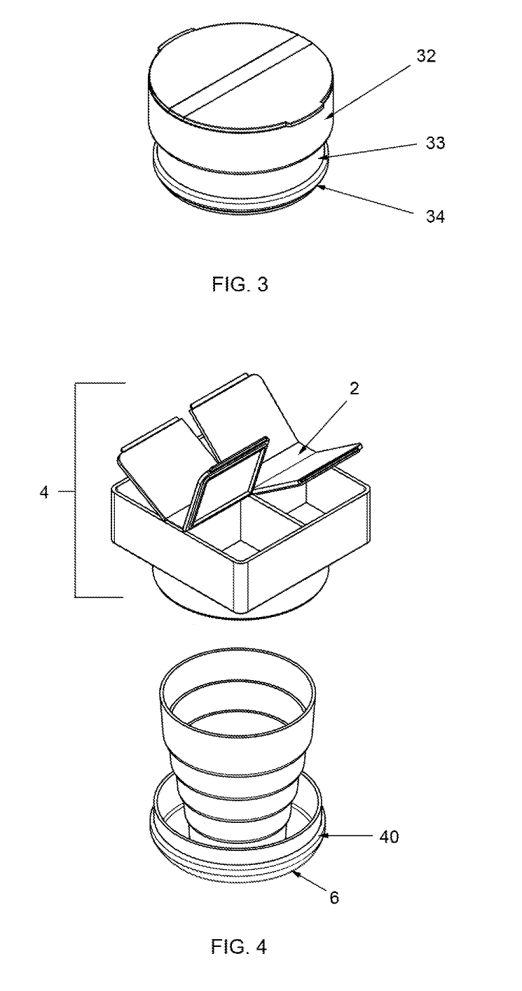

FIGS. 2A, 2B and 2C depict the cover 4 having a rectangular compartment 2, according to one or more embodiments. The shape and position of the compartment 2 results in areas that overhang the platform 10, and thereby assists the user gripping the top cover when opening the cup for use. Further, the compartment 2 comprises a hinged compartment lid 12 comprising a hinge 14 at which the compartment lid 12 is engaged with the compartment 2.

FIG. 3 depicts the cover 4 having a circular compartment 32, according to one or more embodiments. The compartment 32 is attached to circular shaped platform 10, which friction fits onto a round cup base 34 (similar to the base 6 of FIG. 1A). The diameter of the compartment 32 is larger than the diameter of a platform 33 (similar to platform 10 of FIG. 1A), so as to form an overhang 5a, just above the platform 33 which assists the user gripping the top cover when opening the cup for use.

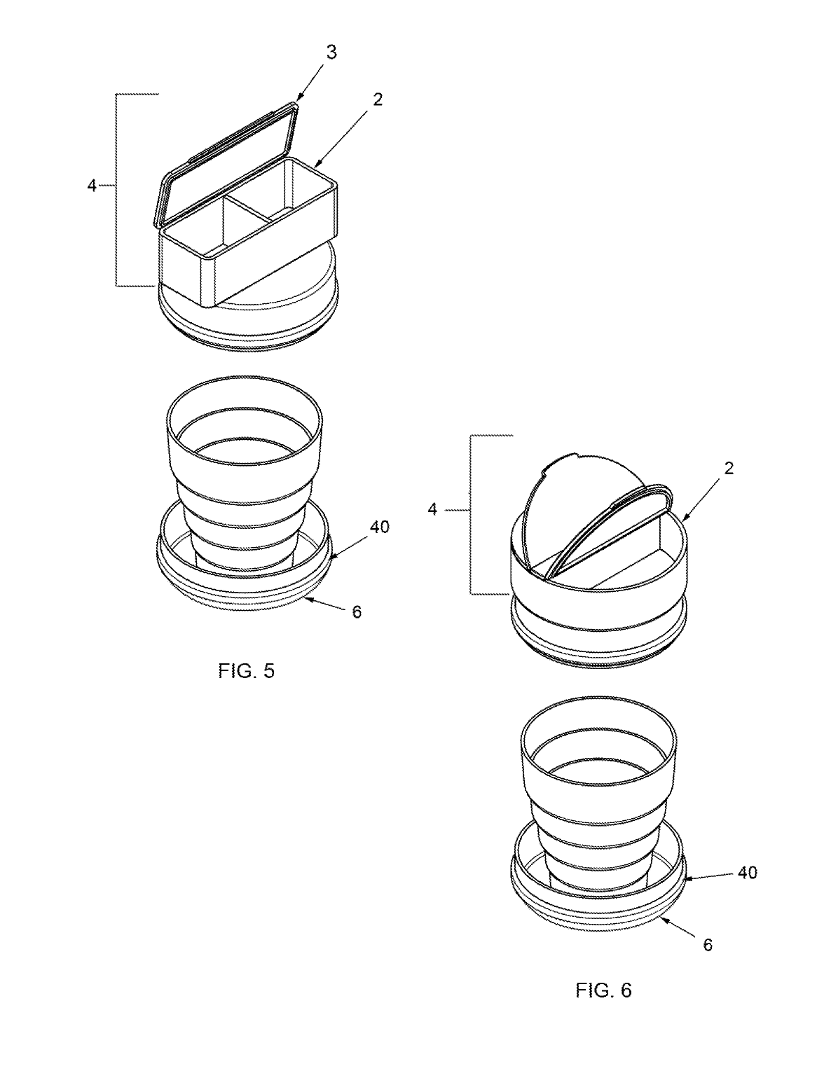

FIG. 4 depicts the cover 4 having square shaped compartment 2 and the base 6 having a gripping element 40 or a ridge 40, according to one or more embodiments. The base 6 includes a continuous base ridge 40 that enlarges the portion of the cup base 6 that has the friction fit with the cover 4. The enlarged portion 40 is an example of a grip enhancing element that provides an easily grippable base, which assists the user gripping the base 6 when trying to separate cover 4 from the base 6 so as to open the cup 8 for use.

FIG. 5 depicts the cover 4 having rectangle shaped compartment 2 having two compartments therein, and a combined compartment lid 3 for engaging with the two compartments in the compartment 2, according to one or more embodiments. FIG. 6 depicts the cover 4 having circle shaped compartment 2 and the base 6 having the continuous thick ridge 40, according to one or more embodiments.

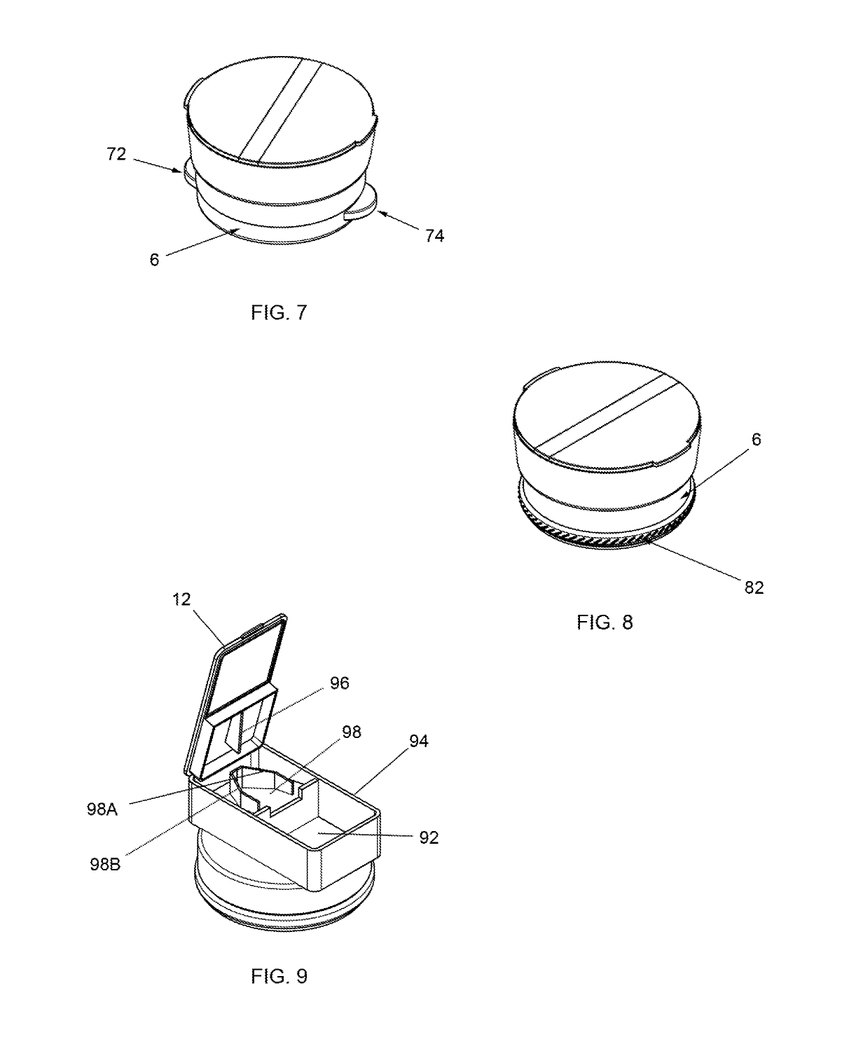

FIG. 7 depicts the base 6 having two protruding ridges 72 and 74, according to one or more embodiments. The two ridges 72 and 74 disposed in opposing position on the base 6, provide a grip to a user trying to separate the top cover 4 from the base 6, in order to open the cup 8 for use. Typically, one hand would be used for gripping the cover 4 using the overhang portion, and the other hand would be used for gripping the base 6 at the ridges 72, 74, and opening could be achieved by pulling, twisting and the like to separate a cover engaged with the base using friction fit.

FIG. 8 depicts the ridge 40 having a textured area 82, according to one or more embodiments. The textured area 82, such as may be formed by cross-hatching on the enlarged continuous base ridge 40, to further assist the user when trying to separate the top cover 4 from the base 6 so as to open the cup 8 for use.

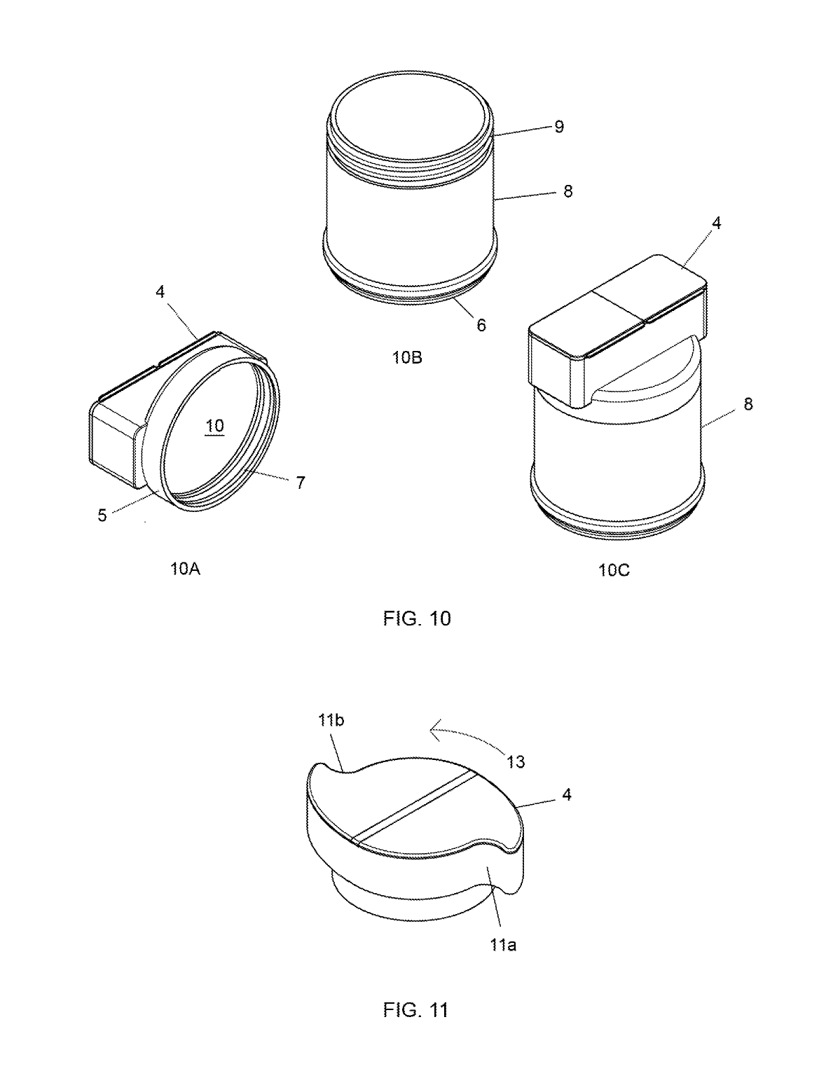

FIG. 9 depicts the compartment 2 having a hinged compartment lid 12 with a cutting element 96. The compartment 2 is rectangular-shaped and divided into two equally sized compartments 92 and 94, and having the hinged compartment lid 12 selectively operated by the user to open and close the compartment 2. In accordance with another embodiment of the invention, the compartment 92 is a pill storage area, and the compartment 94 operates in combination with the cutting element 96, for example a blade, attached to the hinged compartment lid 12, so as to form a pill cutting area, where pills can be cut by the user closing the hinged compartment lid 12 while a pill is held in a receptacle 98. The receptacle 98 is enclosed by side walls 98A and 98B extending vertically within the compartment 94, thereby cutting such pill into smaller pieces, such as into two smaller pieces.

The collapsible cup 8 can be made to many sizes although those most commonly found have a cup base of approx. 2.5″. The storage-incorporating cover can be sized proportionally to the cup size. In some embodiments the cover can be sized to engage smaller cups, while keeping the storage compartment size large, having relatively larger overhanging portion for smaller cups. The compartments can be sized as desired, in relation to or independent of the cup size.

FIG. 10A illustrates a storage incorporating cover 4 comprising a platform 10 or lid 10 and peripheral wall 5 extending from the periphery of the platform 10. The peripheral wall 5 includes screw threads 7 to engage with mating screw threads of a cup, for example as shown by screw threads 9 on a cup 8 having a base 6 in FIG. 10B. FIG. 10C depicts the cover 4 screwed onto the cup 8, forming an enclosed volume (not shown) formed therebetween. The screw threads enable mating the cover 4 with the cup by engaging the cover 4 with the cup 8 and twisting in clockwise or anticlockwise direction to close the cover onto the cup, and correspondingly, twisting in an opposite direction to open the cover. The overhang of the compartment on the cover provides a useful grip to a user to twist open the cover 4. In absence of the overhang which provides the additional grip, the user would have to exert a larger force to unscrew and open the cover, which problem is alleviated by the embodiments described herein.

FIG. 11 illustrates a storage incorporating cover having an overhang portion shaped to provide recesses 11a and 11b for engaging the fingers, and assisting in a twisting motion. For example, to unscrew the cover 4 off a cup (not shown) by rotating the cover 4 in a counterclockwise direction, a user can push using two fingers (or one finger and one thumb) at the recesses 11a and 11b, greatly reducing the required effort to unscrew the cover 4.

According to some embodiments, one or more components described above can be made by injection molding techniques by injecting molten plastic in correspondingly shaped molds. According to some embodiments, one or more components described above can be made individually and joined together, for example, by glue, ultrasonic welding, among other well known techniques, to achieve the desired aggregated structure.

While known collapsible cups usually have a round top cover that forms a friction fit with a round base (alternatively the water-tight fit can be accomplished by a screw arrangement) in other embodiments of this invention cup top covers can be achieved using square, rectangle and other shapes that the collapsible cup can be housed in, and the corresponding base may have a shape that follows that design shape while still having the one or more overhanging grip areas on both the base and the cover.

The above described FIGS. 1-11 illustrate only a few of the many variations of the invention so as to provide a thorough understanding of invention. However, it will be understood by those skilled in the art that these may be practiced without these specific details. For example, as the inventive cup top cover and storage area may be provided separately from the remainder of the cup. Additionally, although the cross-hatching 82 is shown in FIG. 8 is shown on the enlarged continuous base ridge 40, the cross-hatching can be on a base 6 that is not enlarged. It is also noted that methods, apparatuses or systems that would be known by one of ordinary skill have not been described in detail so as not to obscure inventive subject matter.

While the embodiments described herein recite specific examples, other configurations with different permutations and combinations of features described herein would occur readily to those skilled in the art, and in included within the scope and the spirit of the invention as embodied by the claims.

1. A device comprising a cover for a cup, the cover comprising:
a lid having a periphery;
a peripheral wall extending from the periphery of the lid generally oblique or perpendicular to the general orientation of the lid; and
a compartment attached to or formed within the lid, the compartment forming a unitary structure of the lid and the compartment, wherein the compartment extends beyond the periphery to create an overhang portion of the compartment beyond the lid.

2. The device of claim 1, wherein the peripheral wall is shaped to engage with a top opening of a cup, and wherein the cover is configured to form a first enclosed volume in conjunction with the cup when the cover is engaged with the cup along the peripheral wall.

3. The device of claim 2, wherein the cup is a collapsible cup.

4. The device of claim 1, wherein the overhang portion comprises at least two overhang portions, each extending in opposite directions.

5. The device of claim 1, wherein the compartment comprises at least two compartments.

6. The device of claim 5, wherein the compartment comprises a shape from at least one of a rectangle, a circle, a trapezium, a polygon, a semi-circle, animal shapes, irregular shapes, or a combination thereof.

7. The device of claim 1, further comprising a compartment lid covering the compartment, the compartment lid and the compartment forming a second enclosed volume in a closed configuration of the compartment lid comprising the compartment lid engaged with the compartment.

8. The device of claim 7, wherein the compartment lid is at least partially transparent.

9. The device of claim 7, further comprising a hinge which movably couples the compartment lid to the compartment.

10. The device of claim 9, wherein the compartment lid comprises cutting element configured to cut a pill positioned in the compartment underneath the cutting element.

11. The device of claim 2, wherein the peripheral wall is configured to engage with the cup via a friction fit.

12. The device of claim 2, wherein the peripheral wall comprises a screw thread, and wherein the peripheral wall is configured to engage with the cup via a screw arrangement.

13. The device of claim 1 further comprising a cup.

14. The device of claim 13, wherein the cup further comprises a gripping element positioned on along a base of the cup.

15. The device of claim 14, wherein the gripping element comprises a ridge extending sideways from the base in a direction generally perpendicular to a sidewall of a cup.

16. The device of claim 1, wherein the lid is generally flat.

17. A method of manufacturing a cover for a collapsible cup, the method comprising:
injection molding a
a lid having a periphery,
a peripheral wall extending from the periphery of the lid generally oblique or perpendicular to the general orientation of the lid,
a compartment attached to or formed within the lid, the compartment forming a unitary structure of the lid and the compartment, wherein the compartment extends beyond the periphery to create an overhang portion of the compartment beyond the lid, and
a hinge on the compartment; and
mounting a compartment lid to the hinge to couple the compartment lid movably on the compartment, the compartment lid covering the compartment, the compartment lid and the compartment forming a first enclosed volume in a closed configuration of the compartment lid comprising the compartment lid engaged with the compartment,
wherein the peripheral wall is shaped to engage with a top opening of a cup, and wherein the cover is configured to form a second enclosed volume in conjunction with the cup when the cover is engaged with the cup along the peripheral wall.
